(19) United States
(12) Patent Application Publication
(10) Pub. No.: US 2010/0225440 A1
(43) Pub. Date: Sep. 9, 2010

(54) LOCK MECHANISM

(76) Inventors: Alan James Maple, Cheadle (GB); Ian Martin Lennard, Cheadle (GB)

Correspondence Address: MCGARRY BAIR PC, 32 Market Ave. SW, SUITE 500, GRAND RAPIDS, MI, 49503, US

(21) Appl. No.: 12/785,819

(22) Filed: May 24, 2010

Related U.S. Application Data
(63) Continuation of application No. 10/599,198, filed on Sep. 22, 2006.

(30) Foreign Application Priority Data
Mar. 22, 2004 (GB) 04 06376.4

(51) Int. Cl. G05B 19/00; E05B 67/02; E05B 53/00; E05B 41/00; E05B 67/08; E05B 49/00; E05B 65/04

(52) U.S. Cl. 340/5.1; 70/52; 70/263; 70/432; 70/53; 70/278.7; 70/91

(57) ABSTRACT

A lock mechanism for sealing a goods compartment has a housing (10) supporting a shackle (62) movable between open and closed positions to permit hoops on the ends of an elongate sealing member (44) to be connected thereto and then held thereby. The shackle (62) is retained in its closed position by a spying loaded push-button (32) and also by an auxiliary lock (64) including an electric actuator (71) controlled by a control unit (15). The housing (10) has a display device (17, 18, 19) to indicate the lacking condition and sealing of the mechanism and also has a proximity card reader adapted to read information from a presented smartcard, operation of the auxiliary lock (64) being controlled by presentation of an appropriate smartcard.

### CROSS-REFERENCE TO RELATED APPLICATIONS

This application is a continuation of U.S. application Ser. No. 10/599,198, filed Sep. 22, 2006, which claims priority on International Application No. PCT/GB2005/001143, filed Mar. 21, 2005, which claims the benefit of British Patent Application No. GB0406376.4, filed Mar. 22, 2004, all of which are incorporated herein in their entireties.

### BACKGROUND OF THE INVENTION

1. Field of the Invention

This invention relates to a lock mechanism. In particular, but not exclusively, this invention concerns a lock mechanism suitable for use on a sliding or hinged door of an access opening to a goods compartment, such as on a vehicle, a cargo container, a rail wagon or the like.

2. Description of the Related Art

Access openings to goods compartments such as on the above frequently have doors which must be locked shut, in order to prevent unauthorised access to the compartment. There have been numerous lock mechanisms designed to fulfil this purpose, ranging from simple bolts which may be mechanically secured in the locked position when a door associated with the bolt has been closed and the bolt has been shot home, to complex remote controlled lock mechanisms, operated for example pneumatically or by an electric actuator.

A problem with these various lock mechanisms is that if, following authorised access to a goods compartment, a door is shut and then locked in its closed position, and is still shut and locked when access is required again, there has to be a presumption that there has been no unauthorised access since the door was last locked. However, there may have been unauthorised access performed in such a way that following that unauthorised access the door was shut and locked without leaving a trace of the unauthorised access.

In an attempt to address this problem there have been proposals for lock mechanisms which incorporate a seal arrangement, wherein a seal will be broken in the event that the lock mechanism has been freed in an unauthorised manner to allow access to the compartment, even if the lock mechanism is locked once more, following closing of the door. Such mechanisms are satisfactory for several situations but a problem may still arise with mobile goods compartments such as may be found on motor vehicles. Even if the door to such a goods compartment is sealed for example at a depot where the compartment is loaded with goods, there may have been no unauthorised access to the compartment and yet the seal might be broken when the vehicle arrives at its intended destination. For example, the vehicle may have been parked somewhere for a period of time and a third party may have tampered with the lock mechanism so breaking the seal but without gaining access. As the seal has been broken, faith in the integrity of the goods within the compartment will be lost. If the vehicle is carrying foodstuffs, the risk that those goods might have been tampered with is too great and the entire consignment must be condemned.

It is a principal aim of the present invention to address the above problem and so to provide a lock mechanism which is capable of giving a greater degree of security than can be achieved with the known forms of lock mechanisms having a sealing arrangement.

### SUMMARY OF THE INVENTION

According to this invention, there is provided a lock mechanism for use with a component to be locked by the mechanism and which is securable to the lock mechanism or is releasable therefrom, which lock mechanism comprises:
a housing having a bore in which is slidably received a retaining member movable between a first position where the retaining member may be engaged with said component and a second position where the retaining member is disposed deeper in the bore and cannot be disengaged from said component;
a catch member movable between active and inactive positions, the catch member being in its inactive position when the retaining member is in its first position but on moving the retaining member to its second position the catch member moves to its active position engaged with the retaining member to hold the retaining member in its second position, until the catch member is moved back to its inactive position again to free the retaining member for movement to its first position;
an auxiliary lock for the retaining member which auxiliary lock is operable to hold the retaining member in its second position irrespective of operation of the catch member to its inactive position;
an indicator for indicating the locking condition of the mechanism and having at least two indicating states; and
an electronic control unit driving the indicator, the catch member controlling an input to the control unit to indicate when the catch member is in its active position, and the control unit being responsive to an external signal to effect sealing of the lock mechanism and to operate the auxiliary lock, whereby a first indicating state of the indicator may show whether sealing of the lock mechanism is intact and a second indicating state may show whether an attempt has been made to release the lock mechanism since the lock mechanism was last sealed.

Though the lock mechanism of this invention as described above may be used in a variety of situations, its principal use is with a door for closing an access opening to a goods compartment. As such, the invention will be described exclusively with reference to that use, in the following.

The component to be locked by the mechanism may comprise an elongate tension member which may be coupled to the retaining member and which may be passed through apertures provided on the goods compartment door and frame, or a second door. Such a component may have loops at its two ends for coupling with the retaining member. In the alternative, the retaining member may be configured to permit the connection thereto of an enlarged head at one end of the component. The other end of the component may be secured to a fixed item or even the lock housing, or by appropriate configuration of the retaining member, both ends of the component may have enlarged heads for connection to the retaining member.

The component with which the lock mechanism is used serves as a seal arrangement. As such, the component does not need to be of high strength for it need not provide the primary locking function of the lock mechanism. However, release of the component from the lock mechanism is necessary in order to free a compartment door for opening and so the component may perform this sealing function.

Sealing is initiated by closing the compartment door and engaging the component with the retaining member, following which the retaining member is moved to its second position and then is held there by the catch member. Sealing is completed by providing said external signal to the control unit which then operates the auxiliary lock to hold the retaining member in its second position. Upon the catch member moving to its active position said input is supplied to the control unit and provided sealing was completed properly, the control unit drives the indicator to its first indicating state. So long as the integrity of the sealing is maintained, the indicator may continue in its first indicating state.

In the event that an attempt is made to release the lock mechanism in an unauthorised manner by operating the catch member, a corresponding input is supplied to the control unit which then is able to log that fact. However, the retaining member cannot move to its first position notwithstanding the operation of the catch member because the retaining member is held in its second position by the auxiliary lock and so the integrity of the seal is not broken, and the indicator may continue in its first indicating state or give an indication that the catch member has been operated but that the integrity of the seal has not been broken.

Sometimes it happens that a driver or other authorised person is required to gain access to the goods compartment even though not all of the goods within the compartment have reached the ultimate destination. The driver may then release the lock mechanism firstly by providing an appropriate external signal thereto and then by operating the catch member so as to free the component. Following authorised access to the compartment, the driver or other authorised person may reseal the compartment but then the indicator will be driven to its second indicating state, to show that there has been authorised access since the initial sealing.

The indicator may have a third state to show that integrity of the compartment seal has been breached and that there may have been unauthorised tampering with the goods within the compartment, or that the retaining member has been moved to its second position but that the seal has not properly been completed, for example by using an appropriate key.

Conveniently, the indicator has at least two indicator lights, but preferably three such lights, which are selectively driven depending upon the locking condition of the lock mechanism. For example, there may be green, amber and red lights, the green light being illuminated to show the first state, and the green light flashing to show the second state. The amber light may be illuminated to show the third state and the red light to show the fourth state. The lights need not be illuminated continuously; means may be arranged to cause illumination of the appropriate light whenever it is wished to interrogate the integrity of the seal.

The auxiliary lock may include a lock member having locked and free positions. When the retaining member is in its second position, the lock member may be driven to its locked position, to engage the retaining member and so prevent movement of the retaining member from its second position. Thus, the lock member will prevent the retaining member moving to permit release of the component from the retaining member, unless the lock mechanism has deliberately been unsealed.

The lock member may be in the form of a plate having an aperture through which the retaining member passes, the retaining member having a recess in which an edge of the plate defining the aperture may engage, on the lock member moving to its locked position. Alternatively, the lock member may include a plunger mounted within the housing and when in its locked position engages a circumferential groove formed in the retaining member, and also a power-driven actuator to control movement of the plunger. The actuator may have an electric motor which rotates a component to block or permit sliding movement of the plunger. The actuator should be controlled by the control unit.

The external signal supplied to the control unit to effect sealing thereof may be furnished by a card supplied to a card reader associated with the control unit, the card carrying information to be read therefrom. Preferably, the card is in the form of a “smart-card” which may be inserted into the control unit or which may be indirectly interrogated by offering the card close to the control unit. Another possibility is for the control unit to include a receiver for electromagnetic waves of a particular frequency such as radio waves or infrared, whereby sealing of the lock mechanism may be performed remotely by a suitably tuned transmitter transmitting waves appropriately encoded to perform the sealing function.

In one embodiment, the housing has two parallel bores each containing a respective retaining member the arrangement of each of which being essentially the same, whereby the two ends of a component in the form of a flexible cable may be coupled to the two retaining members respectively and so retained within the housing of the lock mechanism when sealing is performed. In an alternative, the retaining member may be in the form of a U-shaped shackle one end of which is free of the housing when the retaining member is in its first position, that one end being received in a further bore in the housing when the retaining member is in its second position.

The catch member may interact with an intermediate portion of the or each retaining member which intermediate portion is of reduced cross-section, whereby the catch member may hold the or each retaining member in its second position by engaging said intermediate portion. For example, the catch member may be slidably mounted in a bore extending transversely to and partially intersecting the bores in which the retaining members are received the catch member having large and small diameter parts which when aligned with the retaining member bores correspond respectively to the active and inactive positions of the catch member. Preferably, the catch member is spring-urged to its active position.

The electronic control unit may be disposed in a separate housing which may be mounted remotely from the housing supporting the retaining member, to facilitate access by an operator.

This invention extends to the combination of a lock mechanism of this invention as described above and a goods compartment having an access opening provided with a door to close that opening, wherein the retaining member may be engaged with a component associated with the compartment door, thereafter to prevent opening of the door without breaking the component.

### BRIEF DESCRIPTION OF THE DRAWINGS

By way of example only, two specific embodiments of sealable lock mechanism of this invention will now be described in detail, reference being made to the accompanying drawings in which:

FIG. 1 is a front view of the lock mechanism housing, with a sealing component removed from the two retaining members;

FIG. 2 is a view of the lower side edge of the housing;

FIG. 3 is a side view of the housing of FIG. 1 but with the retaining members withdrawn into the mechanism;

FIG. 4 is a view similar to that of FIG. 1, but with a cover removed;

FIG. 5 is an exploded diagrammatic view showing the important mechanical parts of the mechanism of FIG. 1;

FIGS. 6A and 6B are respectively sectional and end views on the auxiliary lock for locking the retaining members, when the lock mechanism is sealed and locked;

FIGS. 7A and 7B are similar to FIGS. 6A and 6B but showing the lock mechanism when unlocked;

FIG. 8 is a front view of a modified form of the lock mechanism housing of FIG. 1;

FIG. 9 is an isometric view of a second embodiment of lock mechanism with the retaining member in its first (open) position;

FIG. 10 is a cross-section through the lock mechanism of FIG. 9, in a locked closed (second) position;

FIG. 11 is a view similar to that of FIG. 10 but in a setting intermediate the first and second positions; and

FIG. 12 is an exploded view of the lock mechanism of FIG. 9.

### DESCRIPTION OF AN EMBODIMENT OF THE INVENTION

The embodiments of sealable lock mechanism are intended for use with a goods compartment having an access opening and at least one door to close that opening. Typically, two doors may be provided for the one access opening, and arranged so that one door must be closed first, whereafter the other door may be closed and locked shut, the other door overlapping the one door to a small extent so that the one door also is effectively locked shut.

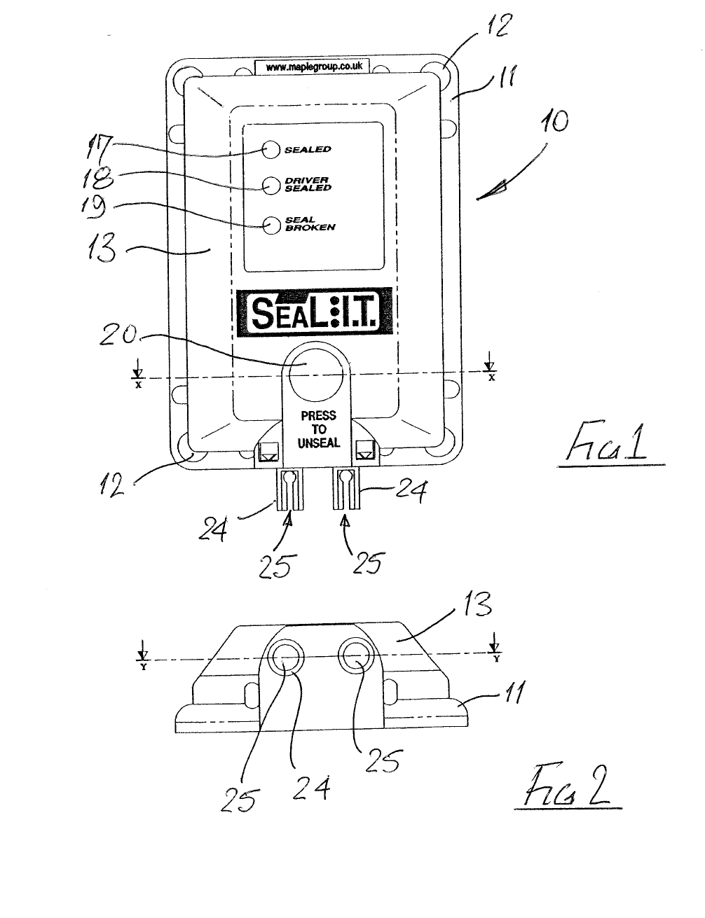

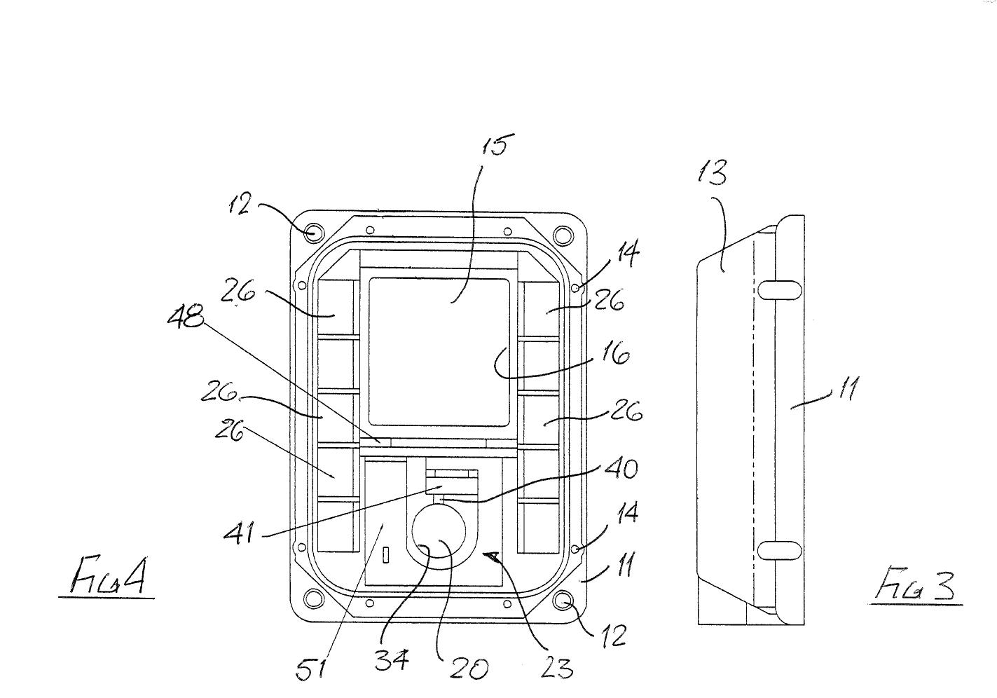

Referring initially to FIGS. 1 to 4 there is shown the housing 10 of the embodiment of sealable lock mechanism. The housing 10 is of generally rectangular form having a base 11 with holes 12 through which mounting screws (not shown) may pass to secure the housing for example to a fixed part of a goods compartment or in the case of a goods compartment with two doors, to one of the doors. A cover 13 is held to the base 11 by screws passing through holes 14 accessible only from the rear of the base, whereby access may be gained to the components mounted within the housing 10.

An electronic control unit 15 is mounted within a compartment 16 in the housing 10, and carries three seal status LEDs 17, 18, 19 which are visible through corresponding windows in the cover 13. The cover carries the legends “SEALED”, “DRIVER SEALED” and “SEAL BROKEN” adjacent each LED respectively. The control unit includes means responsive to an external signal in order to control operation of the lock mechanism and in particular the sealing function thereof. The external signal may be provided by interrogating a smart-card held closely adjacent the housing 10, or there may be a receiver for an electromagnetic wave of an appropriate frequency and suitably encoded.

An end face 20 of a catch member (described below) is exposed through a hole 21 in the cover. A locking unit 23 is mounted on the base 11 and will be described in further detail below. The locking unit 23 has slidably mounted therein a pair of retainers the end portions 24 of which are shown in FIG. 1, projecting below the lower edge of the housing. Each end portion 24 is formed with a transverse slot 25 the cross-section of which is increased at the end of the slot remote from the free end of the retainer.

Also contained within the housing 10 are a plurality of batteries 26 in order that the lock mechanism may be self-contained and not require an external source of electric current.

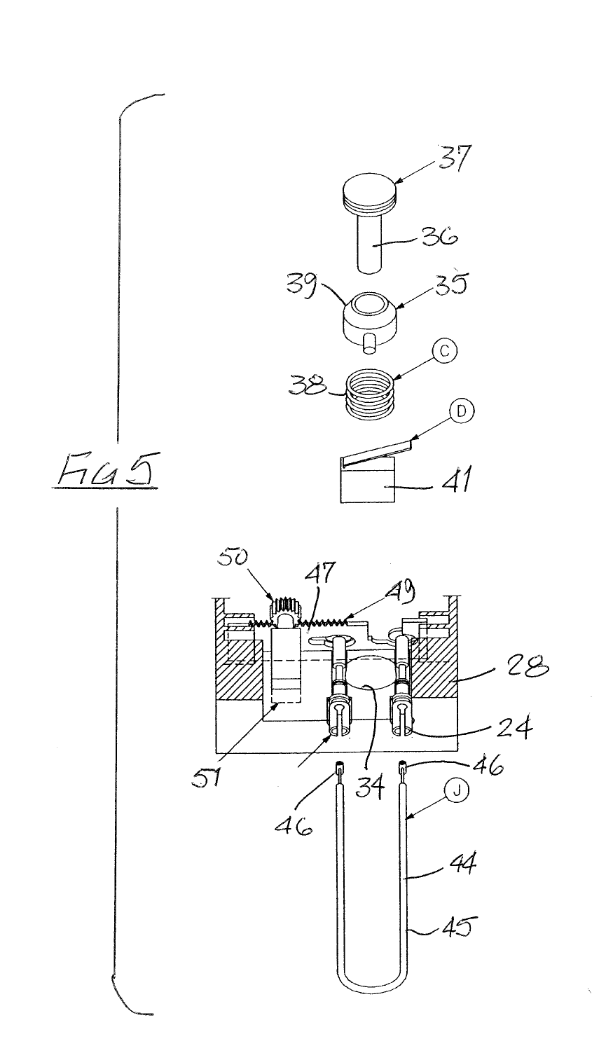

Certain details of the locking unit 23 are shown in FIGS. 5, 6A, 6B, 7A and 7B. The locking unit has a body 28 in which is provided a pair of parallel bores 29 in each of which is carried a respective retainer 30. Each retainer is movable between a first position shown in FIGS. 1 and 5 where the retainer end portion 24 projects from the body, to a second position where the retainer is substantially wholly disposed within its bore. Intermediate the ends of the retainer is a portion 31 of reduced cross-section and a catch member 32 is operable to engage that portion of reduced cross-section, to hold the retainer in its second position, once moved thereto.

The catch member 32 is slidably mounted in a bore 34 extending transversely to and intersecting bores 29, centrally therebetween. The catch member has a wedging part 35 carried on a pin 36 having an enlarged head 37, a spring 38 being provided to urge the catch member 32 to a position where the end face of the enlarged head is essentially flush with the outer surface of the cover 13, when fitted to the base 11. The wedging part 35 is mostly cylindrical but has a conical surface 39 which cooperates with the enlarged head 37 to define a groove therebetween. A peg 40 projects from the cylindrical region of the wedging part and cooperates with an electrical microswitch 41 mounted on the base 11 and connected to the electronic control unit 15.

Movement of the retainers 30 to their first positions is possible only when the groove of the catch member is aligned with the parallel bores 29 so that the portions 31 of the retainers may move away from bore 30 carrying the catch member 32. Such movement of the catch member is performed by depressing the exposed end face of the enlarged head 37 of the catch member, against the action of spring 38. When the retainers are moved to their second positions, where the end portions 24 thereof are disposed within the bores 29, the catch member moves under the action of spring 38 to bring the cylindrical part thereof into alignment with the bores 29 and so locating in the portions 31 of reduced cross-section of the retainers. As such, the catch member then resists movement of the retainers back to their respective first positions until the catch member is once more depressed.

The end portion 24 of each retainer has a transverse slot 25 as has been described above, in which may be received the end 43 of a flexible cable 44 serving as a sealing component for securing the doors of the goods compartment. As shown, the flexible cable is in the form of a Bowden cable having an outer sheath 45 and a steel inner cable fitted with cylindrical nipples 46 at its free ends. The two ends of the cable 44 may be engaged with the two retainer end portions 24 respectively, by transverse movement of each cable end with respect to the axis of the retainer with which that end is to be engaged, the nipple 46 fitting into the enlarged part of the slot until the cable end extends coaxially with the retainer. Once so engaged, the cable end may be pushed towards the interior of the housing, so moving the retainer from its first position shown in FIGS. 1 and 5 to its second position. Once at least the enlarged part of the slot is disposed within the bore 29, the cable end cannot be freed from the retainer.

An auxiliary lock is provided for the retainers, to hold those retainers in their second positions irrespective of actuation of the catch member 32. The auxiliary lock has a plate 47 slidably mounted in a groove 48 provided in the body 28 of the locking unit 23, adjacent the internal ends of the bores 29 such that the plane of the plate is at 90° to the plane containing the axes of the bores 29. Along one edge of the plate there is provided a row of teeth 49 engageable by a pinion 50 driven by an electric motor 51 including an integral gearbox to reduce the rotational speed of the pinion as compared to that of the motor armature.

A slot 53 is formed through the plate 47, the slot having two circular portions 54 connected by a linear portion 55 and which extends beyond one of the portions 54. Each retainer 30 has a washer 56 secured to its inner end by means of a screw 57, the washer being accommodated within a counter bore 58 provided within the body 28. The diameter of the washer 56 is slightly less than the diameter of the corresponding circular portion 54 of the plate 47 so that when suitably aligned, the washer may pass therethrough. The diameter of the adjacent part of the retainer is slightly less than the width of the linear portion 56 of the plate so that the retainer may locate therein.

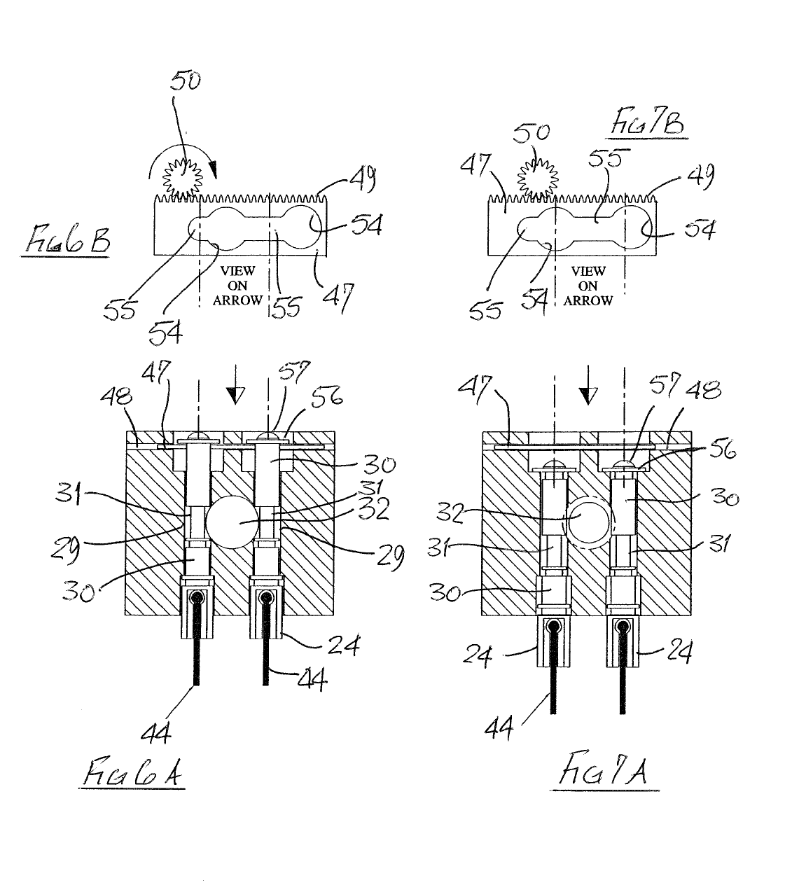

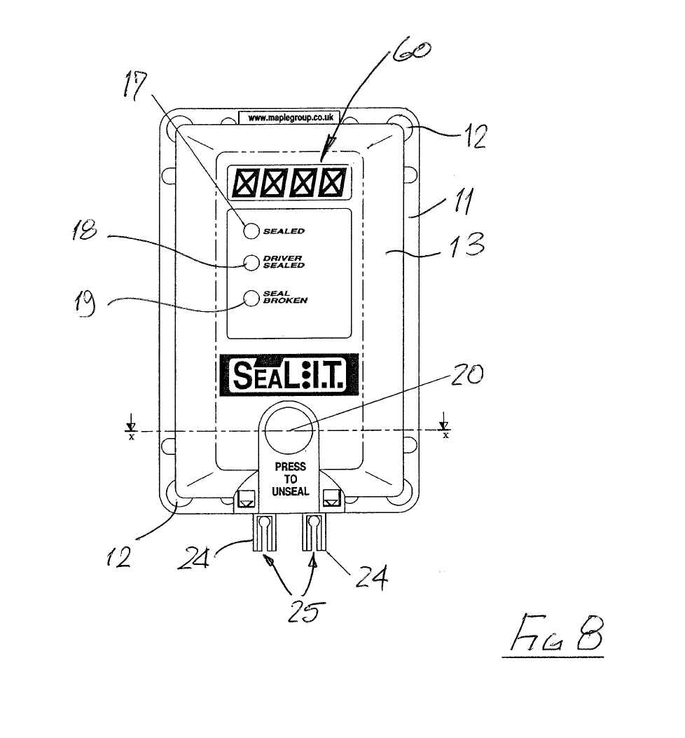

FIGS. 7A and 7B show the retainers in their first positions where the ends 43 of the flexible cable 44 have been engaged with the end portions 24 of the retainers and the plate 47 is moved to a position where its circular portions 54 are aligned with the bores 29. As discussed above, the catch member 32 is in its inactive position. When the retainers have been moved to their second positions, the washers 56 are disposed on the other side of the plate 47 so that the plate may be moved to the position shown in FIGS. 6A and 6B. The catch member moves under the action of spring 38 to its active position to hold the retainers in their second positions. Even if the catch member is moved to its inactive position the retainers cannot move back to their first positions by virtue of the locking action of the plate 47.

In use, the housing 10 is secured to a door or the compartment, such that the flexible cable may be passed through a suitable component associated with the compartment or door, to prevent opening of the door once closed without breaking or releasing the cable. After loading the compartment with goods to be transported elsewhere, the door or doors are closed and locked shut and then the flexible cable is passed through said component and the ends of the cable are engaged with the end portions 24 of the retainers 30. The retainers are moved to their second positions by grasping the cable and pushing it inwardly of the housing, the retainers then being held at their second positions by the automatic action of the catch member 32. This operates the microswitch 41 so notifying the control unit 15 that both retainers are in their second positions.

The lock mechanism may now be sealed by providing the external signal to the control unit. This may be achieved by an operator who has a master sealing smart-card and presenting that card to the housing for interrogation by the control unit. So long as a correct interrogation is achieved, the control unit will be set to a “sealed” status and LED 17, designated “SEALED” will be illuminated. Concurrently, the motor 51 is driven to move the plate 47 to the position shown in FIGS. 6A and 6B.

On arrival of the vehicle at the destination for the goods in the compartment, the status of the lock mechanism may be checked. If LED 17 is still illuminated, the recipient of the goods may be assured that the integrity of the seal has been maintained since loading of the compartment and so accept the delivery.

It sometimes is necessary for a compartment to be opened before the carried goods reach their destination. This may be achieved by an authorized person presenting a suitable smart-card (but not the master sealing card) to the housing, to break the seal and also move the plate 47 to the position shown in FIGS. 7A and 7B. The flexible cable may be removed following operation of the catch member 32 whereafter the doors may be opened. The compartment may then be resealed as described above but using the smart-card and the control unit will recognise the encoding of that smart-card as not being the 30 master sealing card. As such, the control unit will illuminate LED 18 designated “DRIVER SEALED”. On arrival at the destination, the intended recipient of the goods may make enquiries as to why the compartment was opened and resealed, before accepting the delivery.

In the event that the catch member 32 is operated without the seal being broken in an authorised manner, the microswitch 41 will be operated though the retaining members will be held in their second positions by virtue of the interaction between the plate 47 and the retainers 30. As such, the control unit may give an indication that the lock mechanism has been tampered with but the integrity of the seal has not been broken, for example by causing LED 17 to flash.

Should an attempt be made to defeat the system, for example by using an incorrect card or somehow supplying power to the motor to cause the plate 47 to move to the position of FIG. 7B, whereafter the catch member 32 is operated to free the cable 44, it will not then be possible to achieve resealing even though mechanically the cable may be reconnected to the retainers 30 and returning those retainers to their second positions. This will be recognized by the control unit which will then illuminate LED 19, designated “SEAL BROKEN”. The intended recipient of the goods should then refuse delivery.

LED 19 may also be illuminated if the sealing of the system has not properly been completed, for example should the retainers 30 be moved to their second positions so operating the microswitch 41 but the lock mechanism is not sealed by providing the external signal to the control unit.

In order to save battery power, the control unit may be arranged to illuminate the appropriate LED only for a short period of time, following a request for the lock status. This may be obtained by providing a status switch, or by the control unit having a proximity detector responding to the presence of a hand or other object close to the housing.

FIG. 8 shows a modified form of housing differing from that described above only in that there is provided a four-digit symbol display 60 driven by the control unit. The same reference numbers are used in FIG. 8 to show the same parts as those of FIG. 1. The display 60 could be provided instead of the LEDs or in addition thereto. In the former case, the display could show legends to indicate the seal status of the lock mechanism. In the latter case, the display could be used to show a random number which is generated each time the mechanism is sealed. The number may be separately noted when the compartment is first sealed and then compared to a record made of that random number, when the compartment is to be opened at a delivery destination. In that way, a further check on the integrity of the sealing of the compartment may be made.

Though not illustrated, it would be possible to provide the card reader in a separate housing connected to housing 10 by an electrical cable. Instead of the control unit and the power source being mounted within the housing 10, those items may instead be provided within that separate housing.

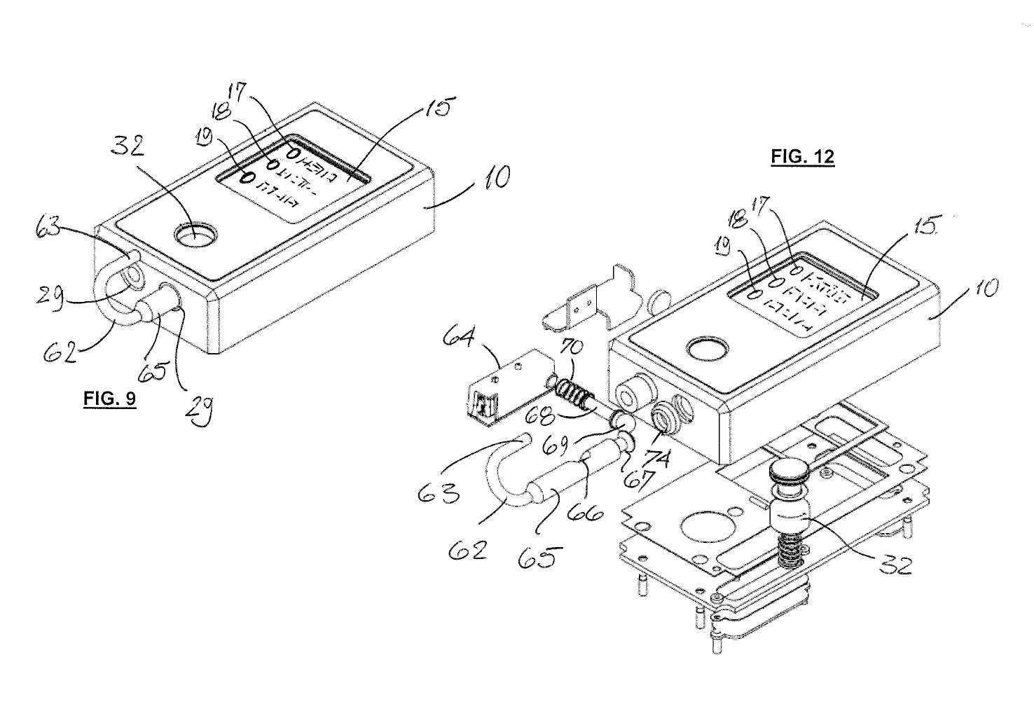

FIGS. 9 to 12 show a second embodiment of lock mechanism of this invention and functionally like parts (though perhaps differing in physical appearance) are given like reference characters and will not be described again in detail here. The second embodiment differs from the first embodiment in two principal respects. Firstly, rather than there being two retainers 30, there is provided a shackle 62 mounted in one bore 29, the free end 63 of the shackle 62 being receivable in the other bore 29 when the shackle is in its second position but that free end being clear of the housing 10 when the shackle is in its first position and so freely rotatable about the axis of said one bore. Secondly, the locking unit 64, though similar to the locking unit 23, is arranged to interact only with arm 65 of the shackle 62 which remains in the housing when the shackle is in its first position.

As will be appreciated, the lock mechanism of the second embodiment more resembles a conventional padlock than does the first embodiment. By providing a shackle 62, operation of the lock mechanism is more familiar to a user. Also, though the shackle may be used with a flexible cable 44, rather than providing nipples 46 on the ends of the cable, there should be formed simple loops at each end and through which the shackle 62 may be passed.

Arm 65 of the shackle is formed with a notch 66 for interaction with the catch member 32. As the rotational position of the shackle will be defined when the shackle is moved to its second position, there is no need for the notch 66 to extend circumferentially. Arm 65 is further provided with a circumferential groove 67 adjacent its innermost end, which groove is engageable by a plunger forming a part of the locking unit 64 when the shackle is in its second position. The plunger comprises a pin 68 and a ball 69 mounted in a transverse bore formed in the housing, the pin 68 being urged by spring 70 to project ball 69 partially out of its bore, that bore having a reduced diameter entrance to ensure the ball 69 cannot leave its bore. The locking unit 64 includes a motor 71 carrying a boss 72 rotatable through 90° and having a transverse hole 73 which may be brought into alignment with the pin 68.

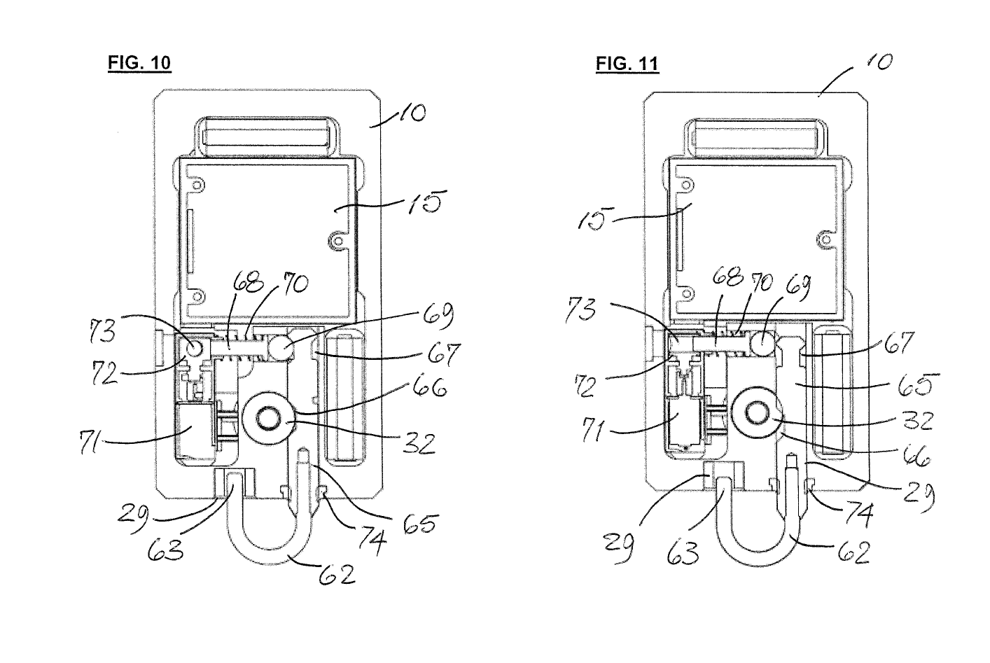

When the shackle 62 is in its second position as shown in FIG. 10, the pin 68 is spring urged to the right (FIG. 10), to push ball 69 partially out of its bore. On moving the shackle from its second position to its first (open) position, the ball and pin are moved to the left by the end of the shackle within the bore (FIG. 11) but the pin 68 may move to the left only when hole 73 in boss 72 is aligned with the pin. When the shackle is in its first position, the ball and pin can move once more to the right to engage the ball 69 in groove 67. Thus, the shackle may be moved from its second position to its first position or from its first position to its second position, only when the hole 73 is aligned with the pin 68. Of course, movement from the second position is possible only once the catch member 32 has been depressed. Once the shackle is in its second position and sealing has been effected by causing the motor to turn boss 72 through 90° so preventing ball 69 moving out of groove 67, the shackle 62 is retained in its second position irrespective of operation of the catch member 32.

In order to resist the ingress of water into the housing, a seal member 74 is fitted to the bore 29 through which arm 65 extends. Water cannot enter the housing through the other bore 29 for receiving the free end of the shackle, as that bore is blind.

In all other respects, this second embodiment corresponds to the first embodiment described with reference to FIGS. 1 to 7, including the functionality thereof, and so will not be described again here.

1. A lock mechanism for use with a component to be locked by the mechanism and which is securable to the lock mechanism or is releasable therefrom, which lock mechanism comprises:
a housing having a bore;
a retaining member slidably received in said bore for movement between a first position where the retaining member is engageable with said component and a second position where the retaining member is disposed deeper in the bore and cannot be disengaged from said engaged component;
a catch member movable between active and inactive positions, said catch member being in its inactive position when the retaining member is in its first position but on moving the retaining member to its second position the catch member moves to its active position engaged with the retaining member to hold the retaining member in its second position, and on moving said catch member back to its inactive position again the retaining member is freed for movement to its first position;
an auxiliary lock for the retaining member, said auxiliary lock being operable to hold the retaining member in its second position irrespective of operation of the catch member to its inactive position;
an indicator for indicating the locking condition of the mechanism and having at least two indicating states; and
an electronic control unit driving said indicator and having an input derived from said catch member to indicate when the catch member is in its active position, said control unit further being responsive to an external signal to effect sealing of the lock mechanism and to operate the auxiliary lock, whereby a first indicating state of the indicator shows whether sealing of the lock mechanism is intact and a second indicating state shows whether an attempt has been made to release the lock mechanism since the lock mechanism was last sealed.

2. A lock mechanism as claimed in claim 1, wherein the auxiliary lock includes a bolt having locked and free positions, said bolt in its locked position engaging the retaining member to prevent movement thereof from its second position, and the bolt when in its free position permitting the retaining member to move to or from its first position.

3. A lock mechanism as claimed in claim 2, wherein said bolt comprises a plate slidably mounted in the housing and having an aperture, said retaining member passing through said aperture and having a recess engaged by said plate when in its locked position.

4. A lock mechanism as claimed in claim 2, wherein said bolt comprises a plunger mounted within the housing, said plunger when in its locked position engaging a circumferential groove formed in the retaining member.

5. A lock mechanism as claimed in claim 2, wherein a power-driven actuator is provided to cause movement of the bolt between its said locked and free positions, the operation of the actuator being controlled by the control unit.

6. A lock mechanism as claimed in claim 5, wherein sealing of the lock mechanism causes the bolt to be moved to its locked position to prevent subsequent movement of the retaining member to its first position until the lock mechanism has been unsealed.

7. A lock mechanism as claimed in claim 1, wherein the indicator has a third indicating state corresponding to the retaining member being in its second position and the catch member in its active position, but the auxiliary lock has not been operated to hold the retaining member in its second position.

8. A lock mechanism as claimed in claim 7, wherein the indicator has a fourth indicating state corresponding to movement of the catch member to its inactive position following sealing of the lock mechanism by the auxiliary lock, whereby the retaining member is not freed to move to its first position.

9. A lock mechanism as claimed in claim 1, wherein the indicator has at least two indicator lights the illumination whereof is controlled by the control unit.

10. A lock mechanism as claimed in claim 1, wherein the control unit includes a card reader for reading information carried on a card, whereby sealing of the lock mechanism may be performed by a person in possession of a suitable card.

11. A lock mechanism as claimed in claim 10, wherein the control unit is arranged to permit initial sealing of the mechanism by a first card carrying appropriate information, and resealing by a second card carrying appropriate but different information.

12. A lock mechanism as claimed in claim 1, wherein the control unit includes a receiver for electromagnetic waves of a defined frequency whereby sealing of the lock mechanism may be performed remotely by a suitably tuned transmitter transmitting waves appropriately encoded to perform sealing of the lock mechanism.

13. A lock mechanism as claimed in claim 1, wherein said component is in the form of a flexible cable having at one end an enlarged head engageable with the retaining member.

14. A lock mechanism as claimed in claim 1, wherein the retaining member is in the form of a U-shaped shackle one end of which is free of the housing when the retaining member is in its first position, said one end being received in a further bore in the housing when the retaining member is in its second position.

15. A lock mechanism as claimed in claim 1, wherein the retaining member has an intermediate portion of reduced cross section and which remains in the bore in the housing when the retaining member is in its first position, the catch member being slidably mounted in a bore extending transversely to and partially intersecting the bore in which the retaining member is received, the catch member having large and small diameter parts which when aligned with the retaining member bore correspond respectively to the active and inactive positions of the catch member.

16. A lock member as claimed in claim 15, wherein the catch member is spring-urged to its active position.

17. A lock mechanism as claimed in claim 1 and including an electrical switch operable on movement of the catch member between its two positions and connected to the control unit to furnish said input thereto.

18. The combination of a lock mechanism as claimed in claim 1 and a goods compartment having an access opening provided with a door to close that opening, wherein the retaining member is engageable with a component associated with the compartment door, thereafter to prevent opening of the door.
